(19) United States
(12) Patent Application Publication
(10) Pub. No.: US 2017/0157674 A1
(43) Pub. Date: Jun. 8, 2017

(54) METHODS OF FORMING POLYCRYSTALLINE TABLES AND POLYCRYSTALLINE ELEMENTS

(71) Applicant: Baker Hughes Incorporated, Houston, TX (US)

(72) Inventor: Danny E. Scott, Montgomery, TX (US)

(21) Appl. No.: 15/438,494

(22) Filed: Feb. 21, 2017

Related U.S. Application Data
(62) Division of application No. 13/040,900, filed on Mar. 4, 2011.

(51) Int. Cl. B22F 7/06; B22F 3/24; E21B 10/567; B22F 7/08; C22C 26/00; B28B 3/02; B22F 3/10; B22F 7/00

(52) U.S. Cl. CPC B22F 7/062; B22F 3/1021; B22F 3/24; B22F 7/008; B22F 7/08; C22C 26/00; B28B 3/025; E21B 10/567; B22F 2005/001

(57) ABSTRACT

Methods of forming a polycrystalline element comprise disposing a first plurality of particles comprising a superabrasive material, a second plurality of particles comprising the superabrasive material, and a catalyst material in a mold. The first and second pluralities of particles are sintered to form a polycrystalline table comprising a first region having a first permeability and a second region having a second, greater permeability. Catalyst material is at least substantially removed from the polycrystalline table. The polycrystalline table is attached to an end of a substrate, the at least a second region being interposed between the first region and the substrate. Polycrystalline elements comprise a substrate. A polycrystalline table comprising a superabrasive material and having a first region exhibiting a first permeability and at least a second region exhibiting a second, greater permeability is attached to an end of the substrate.

### CROSS-REFERENCE TO RELATED APPLICATION

This application is a divisional of U.S. patent application Ser. No. 13/040,900, filed Mar. 4, 2011, pending, the disclosure of which is hereby incorporated herein in its entirety by this reference.

### TECHNICAL FIELD

Embodiments of the present invention relate generally to methods of forming polycrystalline tables, methods of forming polycrystalline elements, and related structures. Specifically, embodiments of the disclosure relate to methods for attaching fully leached or substantially fully leached polycrystalline tables to substrates to form polycrystalline elements, and intermediate structures related thereto.

### BACKGROUND

Earth-boring tools for forming wellbores in subterranean earth formations may include a plurality of cutting elements secured to a body. For example, fixed-cutter earth-boring rotary drill bits (also referred to as “drag bits”) include a plurality of cutting elements that are fixedly attached to a bit body of the drill bit. Similarly, roller cone earth-boring rotary drill bits may include cones that are mounted on bearing pins extending from legs of a bit body such that each cone is capable of rotating about the bearing pin on which it is mounted. A plurality of cutting elements, known in the art as “inserts,” may be mounted to each cone of the drill bit.

The cutting elements used in such earth-boring tools often include polycrystalline diamond compact (often referred to as “PDC”) cutting elements, also termed “cutters,” which are cutting elements that include a polycrystalline diamond (PCD) material, which may be characterized as a superabrasive or superhard material. Such polycrystalline diamond materials are formed by sintering and bonding together relatively small synthetic, natural, or a combination of synthetic and natural diamond grains or crystals, termed “grit,” under conditions of high temperature and high pressure in the presence of a catalyst, such as, for example, cobalt, iron, nickel, or alloys and mixtures thereof, to form a region of polycrystalline diamond material, also called a diamond table. These processes are often referred to as high temperature/high pressure (“HTHP”) processes. The cutting element substrate may comprise a cermet material, i.e., a ceramic-metal composite material, such as, for example, cobalt-cemented tungsten carbide. In some instances, the polycrystalline diamond table may be formed on the cutting element, for example, during the HTHP sintering process. In such instances, cobalt or other catalyst material in the cutting element substrate may be swept into the diamond grains or crystals during sintering and serve as a catalyst material for forming a diamond table from the diamond grains or crystals. Powdered catalyst material may also be mixed with the diamond grains or crystals prior to sintering the grains or crystals together in an HTHP process. In other methods, however, the diamond table may be formed separately from the cutting element substrate and subsequently attached thereto.

To reduce problems associated with differences in thermal expansion and chemical breakdown of the diamond crystals in PDC cutting elements, “thermally stable” polycrystalline diamond compacts (which are also known as thermally stable products or “TSPs”) have been developed. Such a thermally stable polycrystalline diamond compact may be formed by leaching catalyst material out from interstitial spaces between the interbonded grains in the diamond table. When the diamond table is formed separately and subsequently attached to a substrate, also known in the art as a “reattach” process, inadequate attachment may result in delamination of the diamond table from the substrate and premature failure of the cutting element. In addition, catalyst material may sweep from the substrate into the polycrystalline table during the attachment process, and the polycrystalline table may again require leaching to reduce problems associated with differences in rates of thermal expansion and chemical breakdown of the diamond crystals.

### BRIEF SUMMARY

In some embodiments, the disclosure includes methods of forming a polycrystalline element comprising disposing a first plurality of particles comprising a superabrasive material, a second plurality of particles comprising the superabrasive material, and a catalyst material in a mold. The first and second pluralities of particles are sintered in the presence of the catalyst material to form a polycrystalline table comprising a first region having a first permeability and a second region having a second, greater permeability. The catalyst material is at least substantially removed from the polycrystalline table. The polycrystalline table is attached to an end of a substrate comprising a hard material, the at least a second region being interposed between the first region and the substrate.

In other embodiments, the disclosure includes methods of attaching a polycrystalline table to a substrate comprising forming a polycrystalline table of superabrasive material and comprising a first region having a first permeability and a second region having a second, greater permeability. Catalyst material is at least substantially removed from the polycrystalline table. The polycrystalline table contacts an end of a substrate comprising a hard material, the second region being interposed between the first region and the substrate. At least the second region of the polycrystalline table is infiltrated with a flowable material from the substrate.

In additional embodiments, the disclosure includes polycrystalline elements, comprising a substrate comprising a hard material. A polycrystalline table comprising a superabrasive material and having a first region exhibiting a first permeability and at least a second region exhibiting a second, greater permeability is attached to an end of the substrate, the at least a second region being interposed between the substrate and the first region.

### BRIEF DESCRIPTION OF THE SEVERAL VIEWS OF THE DRAWINGS

While the specification concludes with claims particularly pointing out and distinctly claiming that which is regarded as the present invention, various features and advantages of embodiments of this invention may be more readily ascertained from the following description of embodiments of the invention when read in conjunction with the accompanying drawings, in which:

FIG. 1 is a partial cut-away perspective view of a cutting element including a polycrystalline table of the present disclosure;

FIG. 2 illustrates a cross-sectional view of another cutting element including a dome-shaped polycrystalline table of the present disclosure;

FIG. 3 depicts a simplified view of how a microstructure of a first region of a polycrystalline table of the present disclosure may appear under magnification;

FIG. 4 is a simplified view of how a microstructure of a second region of a polycrystalline table of the present disclosure may appear under magnification;

FIG. 5 illustrates a cross-sectional view of a cutting element including another configuration of a polycrystalline table of the present disclosure;

FIG. 6 depicts a cross-sectional view of a cutting element including another configuration of a polycrystalline table of the present disclosure;

FIG. 7 is a cross-sectional view of a cutting element including a non-planar interface design at an interface between a substrate and a polycrystalline table of the present disclosure;

FIG. 8 illustrates a cross-sectional view of a cutting element including a non-planar interface design at an interface between regions within a polycrystalline table of the present disclosure;

FIGS. 9A through 9F depict cross-sectional views of non-planar interface designs that may be used in connection with a polycrystalline table of the present disclosure;

FIG. 10 is a cross-sectional view of a mold used in a process for attaching a polycrystalline table of the present disclosure to a substrate;

FIG. 11 illustrates a cross-sectional view of an intermediate structure in a process for attaching a polycrystalline table of the present disclosure to a substrate;

FIG. 12 depicts a simplified view of how a microstructure of a second region of the intermediate structure shown in FIG. 11 may appear under magnification;

FIG. 13 is a cross-sectional view of a mold used in a process for attaching a polycrystalline table to a substrate;

FIG. 14 illustrates a cross-sectional view of a mold, similar to the mold shown in FIG. 10, used in a process for attaching a polycrystalline table of the present disclosure to a substrate; and

FIG. 15 illustrates a perspective view of an earth-boring tool to which a cutting element including a polycrystalline table of the present disclosure may be attached.

### DETAILED DESCRIPTION

The illustrations presented herein are not meant to be actual views of any particular earth-boring tool, cutting element, or bearing, but are merely idealized representations that are employed to describe the embodiments of the disclosure. Additionally, elements common between figures may retain the same or similar numerical designation.

The terms “earth-boring tool” and “earth-boring drill bit,” as used herein, mean and include any type of bit or tool used for drilling during the formation or enlargement of a wellbore in a subterranean formation and include, for example, fixed-cutter bits, roller cone bits, percussion bits, core bits, eccentric bits, bicenter bits, reamers, mills, drag bits, hybrid bits, and other drilling bits and tools known in the art.

As used herein, the term “polycrystalline table” means and includes any structure comprising a plurality of grains (i.e., crystals) of material (e.g., superabrasive material) that are bonded directly together by inter-granular bonds. The crystal structures of the individual grains of the material may be randomly oriented in space within the polycrystalline material.

As used herein, the terms “inter-granular bond” and “interbonded” mean and include any direct atomic bond (e.g., covalent, metallic, etc.) between atoms in adjacent grains of superabrasive material.

The term “sintering,” as used herein, means temperature driven mass transport, which may include densification and/or coarsening of a particulate component, and typically involves removal of at least a portion of the pores between the starting particles (accompanied by shrinkage) combined with coalescence and bonding between adjacent particles.

As used herein, the terms “nanoparticle” and “nano-size” mean and include particles (e.g., grains or crystals) having an average particle diameter of 500 nm or less.

As used herein, the term “material composition” means the chemical composition and microstructure of a material. In other words, materials having the same chemical composition but a different microstructure are considered to have different material compositions.

As used herein, the term “tungsten carbide” means any material composition that contains chemical compounds of tungsten and carbon, such as, for example, WC, W₂C, and combinations of WC and W₂C. Tungsten carbide includes, for example, cast tungsten carbide, sintered tungsten carbide, and macrocrystalline tungsten carbide.

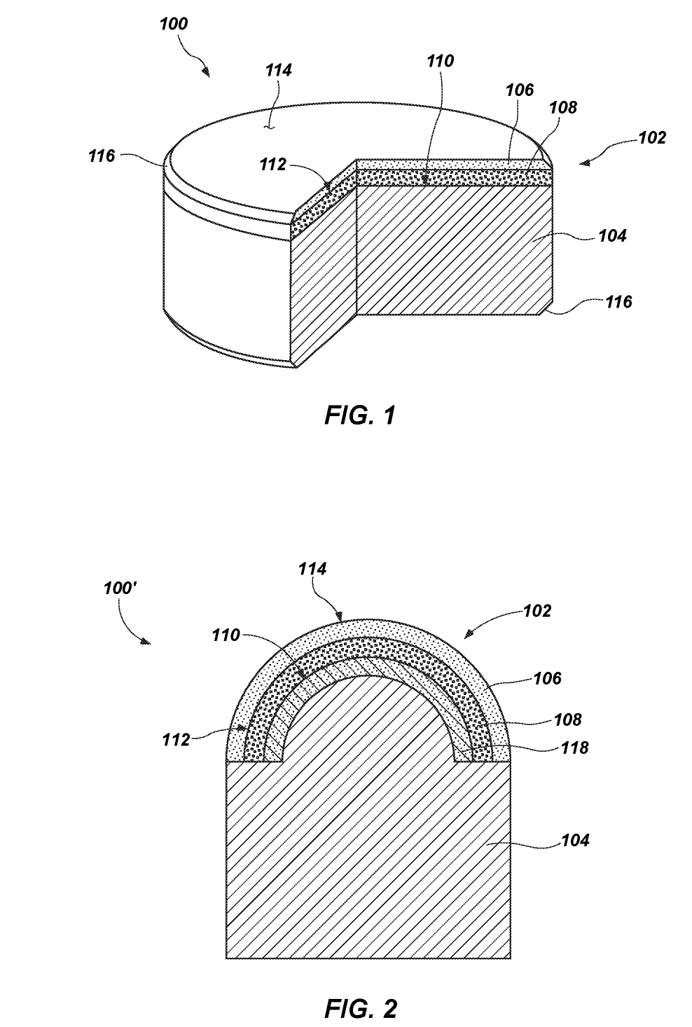

Referring to FIG. 1, a partial cut-away perspective view of a cutting element 100 including a polycrystalline table 102 is shown. The polycrystalline table 102 of the cutting element 100 is attached to an end of a substrate 104. The polycrystalline table 102 may be formed separately from the substrate 104 and subsequently be attached to the substrate 104 in a reattach process. The polycrystalline table 102 comprises a first region 106 having a first permeability and a second region 108 having a second, greater permeability. The second region 108 of the polycrystalline table 102 may be proximate the substrate 104, and the first region 106 may be disposed on an end of the second region 108 opposing the substrate 104. Thus, the second region 108 may be interposed between the first region 106 and the substrate 104. The polycrystalline table 102 may be attached to the substrate 104 at an interface 110. Thus, the interface 110 may comprise a boundary between the second region 108 and the substrate 104. The first region 106 may form a boundary with the second region 108 at another interface 112 within the polycrystalline table 102. In some embodiments, a surface of the first region 106 may form a cutting face 114 of the polycrystalline table 102.

The cutting element 100 may be formed as a generally cylindrical body. Thus, the substrate 104 may comprise a cylinder and the polycrystalline table 102 may comprise another cylinder or disc attached to an end of the substrate 104. The cylindrical substrate 104 may have a circular cross-section. In some embodiments, a chamfer 116 may be formed around the peripheral edges of the polycrystalline table 102, the substrate 104, or both.

The polycrystalline table 102 may comprise a superabrasive, sometimes used interchangeably to mean “superhard,” polycrystalline material. For example, the superabrasive material may comprise synthetic diamond, natural diamond, a combination of synthetic and natural diamond, cubic boron nitride, carbon nitrides, and other superabrasive materials known in the art. Individual grains of the superhard material may form inter-granular bonds to form a superabrasive polycrystalline material.

Typically, a superabrasive polycrystalline material is formed by sintering particles of superabrasive material in the presence of a catalyst material using a high-temperature/high-pressure (HTHP). Suitable catalyst material may include, for example, an alloy (e.g., cobalt-based, iron-based, nickel-based, iron and nickel-based, cobalt and nickel-based, and iron and cobalt-based) or a commercially pure element (e.g., cobalt, iron, and nickel) that catalyzes grain growth and inter-granular bonding. After formation of the superabrasive polycrystalline material, catalyst material may remain in interstitial spaces among the interbonded grains of superabrasive material forming a polycrystalline structure.

The substrate 104 may comprise a hard material suitable for use in earth-boring applications. For example, the hard material may comprise a ceramic-metal composite material (i.e., a “cermet” material) comprising a plurality of hard ceramic particles dispersed throughout a metal matrix material. The hard ceramic particles may comprise carbides, nitrides, oxides, and borides (including boron carbide (B₄C)). More specifically, the hard ceramic particles may comprise carbides and borides made from elements such as W, Ti, Mo, Nb, V, Hf, Ta, Cr, Zr, Al, and Si. By way of example and not limitation, materials that may be used to form hard ceramic particles include tungsten carbide, titanium carbide (TiC), tantalum carbide (TaC), titanium diboride (TiB₂), chromium carbides, titanium nitride (TiN), aluminum oxide (Al₂O₃), aluminum nitride (AlN), and silicon carbide (SiC). The metal matrix material of the ceramic-metal composite material may include, for example, cobalt-based, iron-based, nickel-based, iron and nickel-based, cobalt and nickel-based, and iron and cobalt-based. The matrix material may also be selected from commercially pure elements, such as, for example, cobalt, iron, and nickel. As a specific, non-limiting example, the hard material may comprise a plurality of tungsten carbide particles in a cobalt matrix, known in the art as cobalt-cemented tungsten carbide.

Referring to FIG. 2, another cutting element 100′, such as, for example, an insert for a roller cone in a roller cone earth-boring drill bit, including a dome-shaped polycrystalline table 102 is shown. The polycrystalline table 102 of the cutting element 100′ is attached to an end of a substrate 104. The polycrystalline table 102 may be formed separately from the substrate 104 and subsequently be attached to the substrate 104 in a reattach process. The polycrystalline table 102 includes a first region 106 having a first permeability and a second region 108 having a second, greater permeability. The second region 108 may be interposed between the first region 106 and the substrate 104. The substrate 104 may comprise an intermediate region 118 proximate the second region 108 and forming a boundary with the second region 108 at the interface 110 between the polycrystalline table 102 and the substrate 104. The intermediate region 118 may comprise a layer or stratum of material between the polycrystalline table 102 and the remainder of the substrate 104. The intermediate region 118 may comprise a combination of the superabrasive material of the polycrystalline table 102 and the hard material of the remainder of the substrate 104. Thus, the intermediate region 118 may enhance the attachment strength of the polycrystalline table 102 to the substrate 104 by providing a more gradual transition between the materials thereof.

The polycrystalline table 102 may comprise a dome shape, such as, for example, a hemisphere. The polycrystalline table 102 may comprise a hollow dome shape, as shown. The substrate 104 may comprise a corresponding dome-shaped protrusion that contacts the polycrystalline table 102 at the interface 110 therebetween. A remainder of the substrate 104 may be cylindrical in shape. In other embodiments, the polycrystalline table 102 may comprise a solid dome disposed on a cylindrical substrate 104. In still other embodiments, the polycrystalline table 102 and the cutting element 100 may have other forms, shapes, and configurations known in the art, such as, for example, chisel-shaped, tombstone, etc.

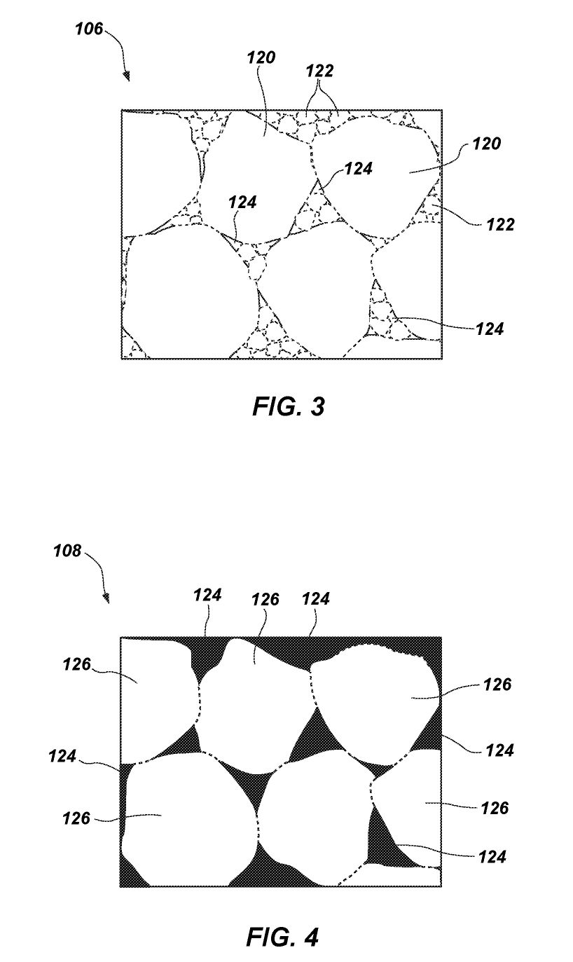

Referring to FIG. 3, a simplified view of how a microstructure of a first region 106 of a polycrystalline table 102, such as the first regions 106 shown in FIGS. 1, 2, and 5 through 9F, may appear under magnification is shown. The first region 106 may comprise a bi-modal grain size distribution, including larger grains 120 and smaller grains 122 of superabrasive material. In other embodiments, the first region 106 may comprise a mono-modal grain size distribution or a multi-modal grain size distribution other than bi-modal (e.g., tri-modal, quinti-modal, etc.). A multi-modal grain size distribution may enable the grains 120 and 122 to be more densely packed (i.e., relatively smaller grains 122 may occupy portions of the interstitial spaces among larger grains 120 that would otherwise be devoid of superabrasive material), resulting in a higher density of superabrasive material within the first region 106. In some embodiments, the first region 106 may include at least some nano-sized grains (i.e., grains having an average particle diameter of 500 nm or less) of superabrasive material. For example, the smaller grains 122 in the bi-modal grain size distribution may comprise nano-sized grains. The larger grains 120 may have an average grain size of, for example, greater than 5 μm, and the smaller grains 122 may have an average grain size of, for example, less than 1 μm. As specific, non-limiting examples, the larger grains 120 may have an average grain size of 5 μm, 25 μm, or even 40 μm, and the smaller grains may have an average grain size of 1μm, 500 nm, 250 nm, 150 nm, or even 6 nm.

The first region 106 may have a first volume percentage of superabrasive material. For example, the grains 120 and 122 of superabrasive material may occupy between 92% and 99% by volume of the first region 106 of the polycrystalline table 102. As a specific, non-limiting example, the grains 120 and 122 of superabrasive material may occupy 95% by volume of the first region 106 of the polycrystalline table 102. A multi-modal grain size distribution, for example, may enable the first region 106 to have a relatively high volume percentage of grains 120 and 122 of superabrasive material. Alternatively or in addition, using relatively small grains may enable the grains 120 and 122 to be more densely packed than relatively larger grains, and therefore impart a higher volume percentage of superabrasive material to the first region 106. Because a large percentage of the volume of the first region 106 is occupied by grains 120 and 122 of superabrasive material, there may be relatively fewer and smaller interstitial spaces 124 through which fluid may flow. Thus, the first region 106 may exhibit a relatively low permeability.

The first region 106 may have a first interconnectivity among interstitial spaces 124 that are dispersed among the interbonded grains 120 and 122 of superabrasive material. For example, at least some of the interstitial spaces 124 may form an open, interconnected network within the microstructure of the first region 106 through which a fluid may flow. Others of the interstitial spaces 124 may remain in closed, isolated spatial regions among the grains 120 and 122, to which fluid may not flow or to which flow may at least be impeded. Because relatively fewer of the interstitial spaces 124 may be connected to the open, interconnected network within the microstructure of the first region 106, the flow of fluid through that network may be impeded. Thus, the first region 106 may exhibit a relatively low permeability.

The grains within the first region 106, such as the larger and smaller grains 120 and 122, may be interbonded in three dimensions to form a polycrystalline structure of superabrasive material. Interstitial spaces 124 among the interbonded grains 120 and 122 of superabrasive material may be at least substantially free of catalyst material. Thus, catalyst material may have been removed, such as, for example, by a leaching process, from all or substantially all of the first region 106. When it is said that the interstitial spaces 124 between the interbonded grains 120 and 122 of superabrasive material in the first region 106 of the polycrystalline table 102 may be at least substantially free of catalyst material, it is meant that catalyst material is removed from the open, interconnected network of spatial regions among the grains 120 and 122 within the microstructure of the first region 106, although a relatively small amount of catalyst material may remain in closed, isolated spatial regions among the grains 120 and 122, as a leaching agent may not be able to reach volumes of catalyst material within such closed, isolated spatial regions.

Referring to FIG. 4, a simplified view of how a microstructure of a second region 108 of a polycrystalline table 102, such as the second regions 108 shown in FIGS. 1, 2, and 5 through 9F, may appear under magnification is shown. The second region 108 may comprise a mono-modal grain size distribution. In other embodiments, the second region may comprise a multi-modal grain size distribution. In either case, grains 126 within the second region 108 and may have a larger average grain size than the average grain size of grains 120 and 122 within the first region 106 (see FIG. 3). For example, the grains 126 within the second region 108 may have an average grain size that is 50 to 150 times larger than the average grain size of grains 120 and 122 within the first region 106. The grains 126 within the second region 108 may have an average grain size that is, for example, at least 5 μm. Thus, the second region 108 may be free of or substantially devoid of nano-sized grains. As specific, non-limiting examples, the grains 126 within the second region 108 may have an average grain size of 5 μm, 25 μm, or even 40 μm. In some embodiments, the grains 126 within the second region 108 may have the same average grain size as at least some grains (e.g., larger grains 120) within the first region 106. In other embodiments, the grains 126 within the second region 108 may have an average grain size that is larger than any average grain size of grains (e.g., larger grains 120 or smaller grains 122) within the first region 106.

The second region 108 may have a second volume percentage of superabrasive material that is greater than the first volume percentage of superabrasive material of the first region 106. For example, the grains 126 of superabrasive material may occupy less than 91% and even as low as 80% by volume of the second region 108 of the polycrystalline table 102. As a specific, non-limiting example, the grains 126 of superabrasive material may occupy 85% by volume of the second region 108 of the polycrystalline table 102. A mono-modal grain size distribution, for example, may enable the second region 108 to have a low volume percentage of grains 126 of superabrasive material when compared to the volume percentage of superabrasive material in first region 106. Alternatively or in addition, using larger grains may enable the grains 126 to be less densely packed than smaller grains (e.g., the grains 120 and 122 of the first region 106), and therefore impart a lower volume percentage of superabrasive material to the second region 108 as compared to the volume percentage of superabrasive material in the first region 106. Because a smaller percentage of the volume of the second region 108 is occupied by grains 126 of superabrasive material, there may be relatively more and larger interstitial spaces 124 through which fluid may flow. Thus, the second region 108 may exhibit a higher permeability than the first region 106.

The second region 108 may have a second, greater interconnectivity among interstitial spaces 124 that are dispersed among the interbonded grains 126 of superabrasive material when compared to the first interconnectivity among interstitial spaces 124 within the first region 106. For example, a greater quantity of the interstitial spaces 124 may form an open, interconnected network within the microstructure of the second region 108 through which a fluid may flow. Fewer of the interstitial spaces 124 in the second region 108 may remain in closed, isolated spatial regions among the grains 126, to which fluid may not flow or to which flow may at least be impeded. Because relatively more of the interstitial spaces 124 may be connected to the open, interconnected network within the microstructure of the second region 108, the flow of fluid through that network may be impeded to a lesser extent. Thus, the second region 108 may exhibit a greater permeability than the first region 106.

The grains 126 of superabrasive material may be interbonded to form a polycrystalline structure. A catalyst material may be disposed in interstitial spaces 124 among the interbonded grains 126 of superhard material. The same catalyst material may also be found in the substrate 104 (see FIGS. 1 and 2). For example, the metal matrix of the hard material of the substrate 104 may comprise a catalyst material that flows and migrates (i.e., sweeps) from the substrate 104 into the second region 108 of the polycrystalline table 102 while the polycrystalline table 102 is attached on an end of the substrate 104, for example, during a reattach process. In some embodiments, the catalyst material disposed in the interstitial spaces 124 among interbonded grains 126 of superabrasive material may be a different catalyst material than a catalyst material initially used to form the polycrystalline table 102. As a specific, non-limiting example, cobalt may be used to catalyze formation of the polycrystalline table 102, and nickel may subsequently be swept into the second region 108 of the polycrystalline table 102 during a reattach process. In other embodiments, the catalyst material disposed in the interstitial spaces 124 among interbonded grains 126 of superabrasive material may be the same as the catalyst material initially used to form the polycrystalline table 102.

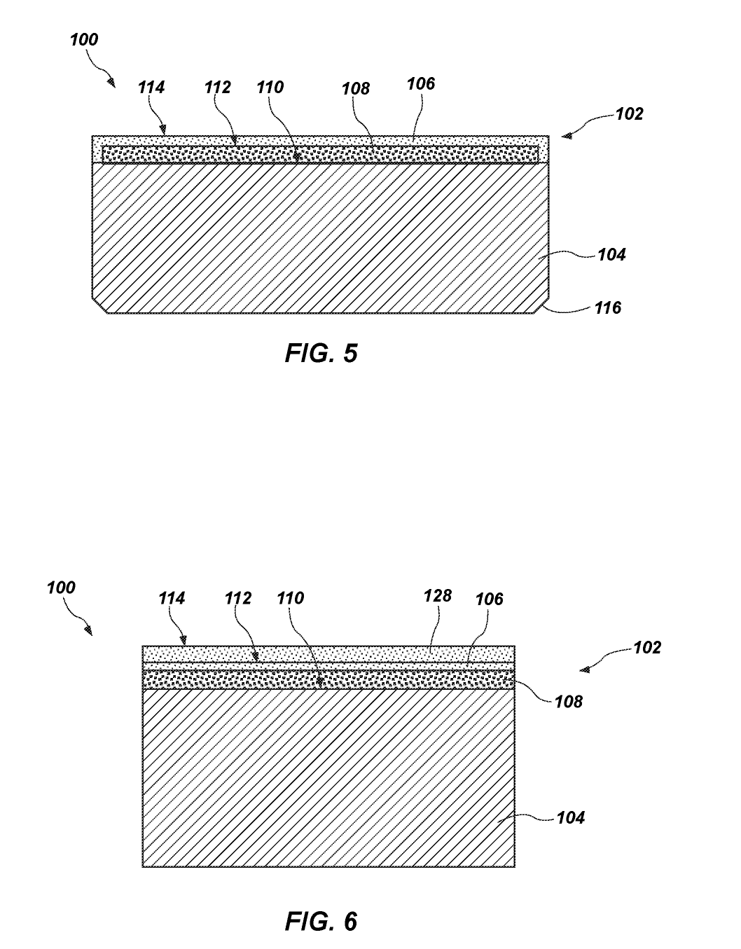

Referring to FIG. 5, a cutting element 100 including another configuration of a polycrystalline table 102 is shown. The first region 106 of the polycrystalline table 102 may extend at the periphery of the polycrystalline table 102 toward the substrate 104, forming an annular body between the second region 108 and an exterior of the cutting element 100. Thus, the first region 106, which may be at least substantially free of catalyst material, may extend from the cutting face 114 of the cutting element 100 toward the substrate 104 and around the periphery of the polycrystalline table 102. The second region 108 may be interposed between the first region 106 and the substrate 104.

Referring to FIG. 6, a cutting element 100 including another configuration of a polycrystalline table 102 is shown. The polycrystalline table 102 may include a third region 128 of polycrystalline superabrasive material. The third region 128 may be disposed on an end of the first region 106 opposing the second region 108. Thus, the first region 106 may be interposed between the second region 108 and the third region 128, and the second region 108 may be interposed between the first region 106 and the substrate 104. The first, second, and third regions 106, 108, and 128 may be provided in layers or strata on the substrate 104. An exposed surface of the third region 128 may form the cutting face 114 of the cutting element 100. The third region 128 may have a third permeability that is lower than the first permeability of the first region 106. In some embodiments, the third region 128 may comprise substantially the same material composition as the second region 108. In other embodiments, the third region 128 may have a material composition that is different from the material composition of the first and second regions 106 and 108. The third region 128, like the first region 106, may be at least substantially free of catalyst material that may otherwise be disposed in interstitial spaces among interbonded grains of superabrasive material.

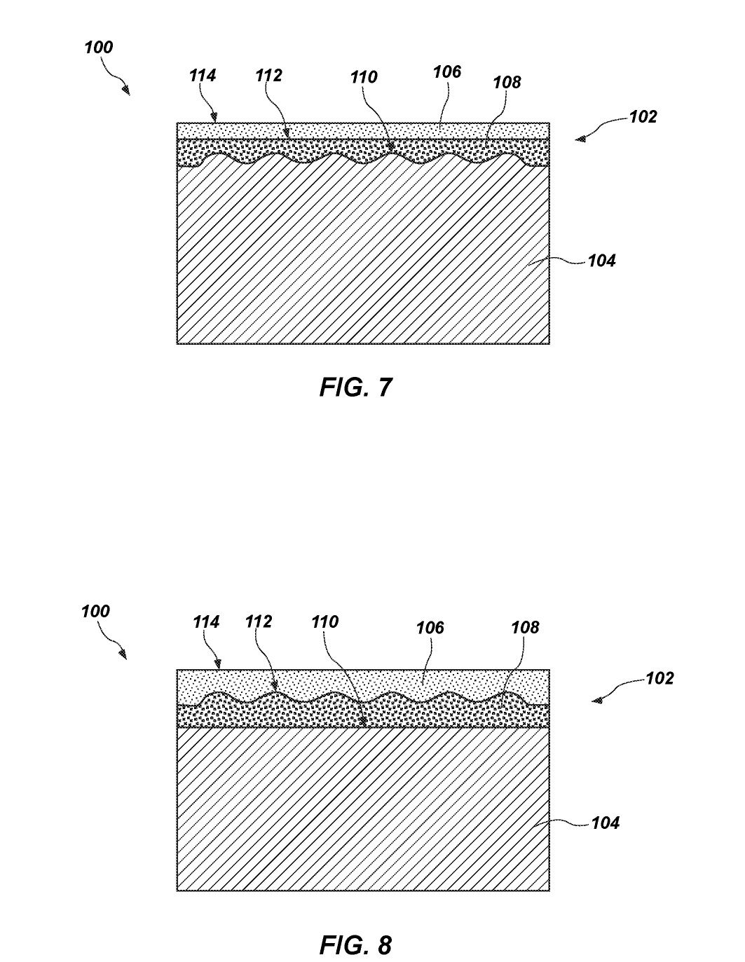

Referring to FIG. 7, a cutting element 100 including a non-planar interface design at the interface 110 between the substrate 104 and the polycrystalline table 102 is shown. The non-planar interface design may enhance the attachment strength of the polycrystalline table 102 to the substrate 104, thereby preventing or minimizing the likelihood of delamination of the polycrystalline table from the substrate 104. The non-planar interface design may comprise a plurality of protrusions and recesses that increase the overall contact area of the interface 110 between the substrate 104 and the polycrystalline table 102. The non-planar interface design may comprise, for example, a series of concentric rings, radially extending spokes, or other non-planar interface designs known in the art.

Referring to FIG. 8, a cutting element 100 including a non-planar interface design at another interface 112 between the first and second regions 106 and 108 within the polycrystalline table 102 is shown. The non-planar interface design may enable selected regions (e.g., the first region 106) to be at least substantially free of catalyst material while other regions (e.g., the second region 108) may have catalyst material disposed in interstitial spaces among interbonded grains of superabrasive material. Thus, catalyst material may not be present in selected, desirable regions, such as, for example, near the cutting face 114 or around the periphery of the polycrystalline table 102. The non-planar interface design may also enhance bonding between the first and second regions 106 and 108 by including a plurality of protrusions and recesses that increase the overall contact area of the other interface 112 between the first and second regions 106 and 108. The non-planar interface design may comprise, for example, a series of concentric rings, radially extending spokes, or other non-planar interface designs known in the art.

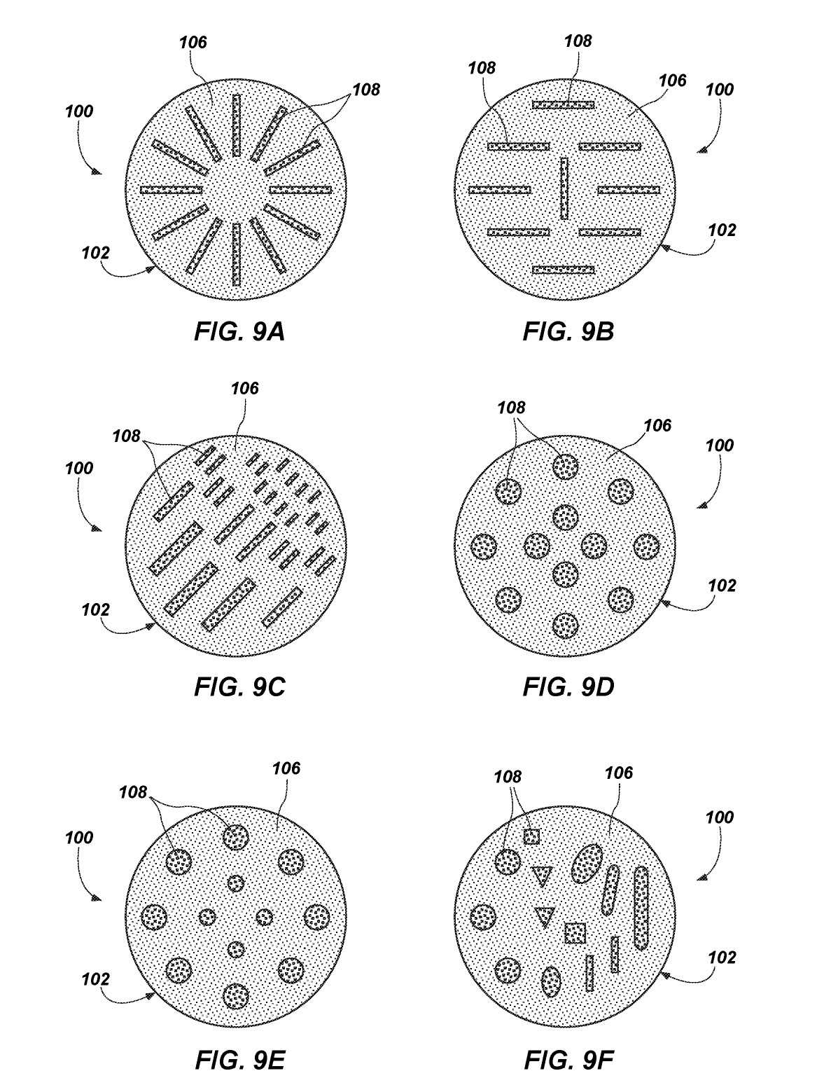

Referring to FIGS. 9A through 9F, non-planar interface designs that may be used in connection with a polycrystalline table 102 and/or a substrate 104 are shown. The views shown are cross-sections taken within the polycrystalline table 102, and depict portions of the first region 106 and the second region 108. Although the non-planar interface designs are depicted as being within the polycrystalline table 102 between the first and second regions 106 and 108 of superabrasive polycrystalline material, similar interface designs may likewise be disposed between the polycrystalline table 102 and the substrate 104 (see FIG. 7).

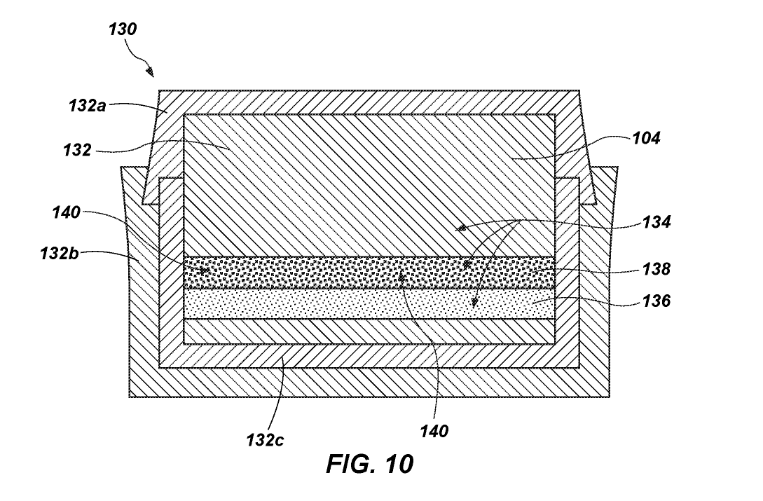

Referring to FIG. 10, a mold 130 used in a process for attaching a polycrystalline table 102 to a substrate 104 is shown. The mold 130 may include one or more generally cup-shaped members, such as cup-shaped member 132a, cup-shaped member 132b, and cup-shaped member 132c, which may be assembled and swaged and/or welded together to form the mold 130. A substrate 104, a catalyst material 134, a first plurality of particles 136, and a second plurality of particles 138 may be disposed within the inner cup-shaped member 132c, as shown in FIG. 10, which has a circular end wall and a generally cylindrical lateral side wall extending perpendicularly from the circular end wall, such that the inner cup-shaped member 132c is generally cylindrical and includes a first closed end and a second, opposite open end. Thus, the mold 130 may impart a generally cylindrical shape to a cutting element 100 formed therein. In other embodiments, the mold may impart other shapes to a cutting element, such as the shapes discussed previously in connection with FIG. 2. In addition, the substrate 104 may be omitted from some other embodiments, and only the catalyst material 134, the first plurality of particles 136, and the second plurality of particles 138 may be disposed in the mold 130. In still other embodiments, ceramic particles and metal particles may be disposed in the mold and subsequently sintered to form a substrate 104 comprising the ceramic particles in a metal matrix.

The first plurality of particles 136 may be configured to form a first region 106 of a polycrystalline table 102 having a first permeability. The second plurality of particles 138 may be configured to form a second region 108 of a polycrystalline table 102 having a second, greater permeability. Thus, the first and second pluralities of particles 136 and 138 may comprise a superabrasive material, such as any of the superabrasive materials discussed previously in connection with FIG. 1. The first plurality of particles 136 may have a first packing density, and the second plurality of particles 138 may have a second, lower packing density in the mold 130. For example, the second plurality of particles 138 may have a mono-modal particle size distribution and the first plurality of particles 136 may have a multi-modal particle size distribution that packs more densely than the second plurality of particles 138. The first plurality of particles 136 may have a first average particle size and the second plurality of particles 138 may have a second, greater average particle size, such as, for example, any of the sizes and size differences discussed previously in connection with FIGS. 3 and 4, although it is noted that the particles may experience some size increase and may also experience some size decrease (e.g., by crushing and fracturing under pressure during an HTHP process) as the particles bond to form the grains of a superabrasive polycrystalline material. At least some particles of the first plurality of particles 136 may comprise nanoparticles.

The catalyst material 134 may comprise any of the catalyst materials discussed previously in connection with FIG. 1. In embodiments where the first and second pluralities of particles 136 and 138 are disposed in the mold 130 with a substrate 104, the catalyst material 134 may be present within the substrate 104. For example, the substrate 104 may comprise a cermet material, and the metal matrix of that cermet material may be a catalyst material. In addition, catalyst material 134 may be disposed in the mold 130 in the form of a catalyst powder that may be intermixed with and interspersed among the first and/or second pluralities of particles 136 and 138. In some embodiments, extra catalyst material 134 (e.g., a quantity of catalyst material that exceeds the minimum quantity necessary to catalyze grain growth and interbonding of the particles) may be intermixed with and interspersed among the second plurality of particles 138. By doing so, the packing density of the second plurality of particles 138 may be further decreased as compared to the packing density of the first plurality of particles 136. In some embodiments, catalyst material 134 may be coated onto the exterior surfaces of other particles in the mold 130 using, for example, a chemical solution deposition process, commonly known in the art as a “sol-gel” process. For example, at least some particles of the first plurality of particles 136 may be coated with the catalyst material 134. In embodiments where the first plurality of particles 136 comprises at least some nanoparticles, the nanoparticles may be coated with the catalyst material 134. Catalyst material 134 may be particularly disposed within or near the first plurality of particles 136 because the flow of catalyst material 134 among the first plurality of particles 136 may be restricted or impeded. By providing catalyst material 134 proximate the first plurality of particles 136, adequate sintering and grain growth may be ensured.

Another plurality of particles 140 comprising a non-catalyst material removable by a leaching agent may also be optionally disposed in the mold 130. For example, the other plurality of particles 140 may comprise gallium, indium, or tungsten. The other plurality of particles 140 may be intermixed with and interspersed among the second plurality of particles 138. By disposing the other plurality of particles 140 in the mold 130, the packing density of the second plurality of particles 138 may be further decreased as compared to the packing density of the first plurality of particles 136.

The first plurality of particles 136, the second plurality of particles 138, the optional substrate 104, and the optional other plurality of particles 140 may be sintered in the presence of the catalyst material 134. For example, an HTHP process may be used to sinter the first plurality of particles 136 and the second plurality of particles 138 to form a polycrystalline table 102 having a first region 106 having a first permeability and a second region 108 having a second, greater permeability. In embodiments where a substrate 104 is also present in the mold 130, the polycrystalline table 102 so formed may be attached on an end of the substrate 104, the second region 108 being interposed between the first region 106 and the substrate 104. Although the specific parameters of the HTHP process may vary depending on the materials used and the quantities of material in the mold 130, a pressure of at least 5 GPa may be applied to the mold 130, while the temperature may be elevated above 1320° C., and the first and second pluralities of particles 136 and 138, along with any other materials and structures in the mold 130, may remain at peak pressure and peak temperature for about 5 minutes. For example, the peak applied pressure may be 6 GPa, 7 GPa, 8 GPa, or even greater. The peak temperature may be, for example, 1400° C. or even greater. The time cycle may be adjusted so that the time at peak pressure and temperature is less than 5 minutes or greater than 5 minutes. The exact conditions may be selected to impart a desired final microstructure (e.g., the microstructures depicted in FIGS. 3 and 4) and associated properties to the resulting polycrystalline table 102. Thus, a polycrystalline table 102 comprising a first region 106 having a first permeability and a second region 108 having a second, greater permeability may be formed.

After sintering, the polycrystalline table 102 may comprise a first volume percentage of catalyst material 134. The first region 106 of the polycrystalline table 102 may comprise a first volume percentage of catalyst material 134 disposed in interstitial spaces among interbonded grains of superabrasive material. The second region 108 may comprise a second, greater volume percentage of catalyst material 134 disposed in interstitial spaces among interbonded grains of superabrasive material. For example, the first region 106 of the polycrystalline table 102 may comprise between 1% and 8% by volume of catalyst material 134. By contrast, the second region 108 may comprise greater than 9% by volume of catalyst material 134, and may even comprise up to 20% by volume of catalyst material. As specific, non-limiting examples, the first region 106 may comprise 5% by volume of catalyst material 134 disposed in interstitial spaces among interbonded grains of superabrasive material, and the second region 108 may comprise 15% by volume of catalyst material 134 disposed in interstitial spaces among interbonded grains of superabrasive material.

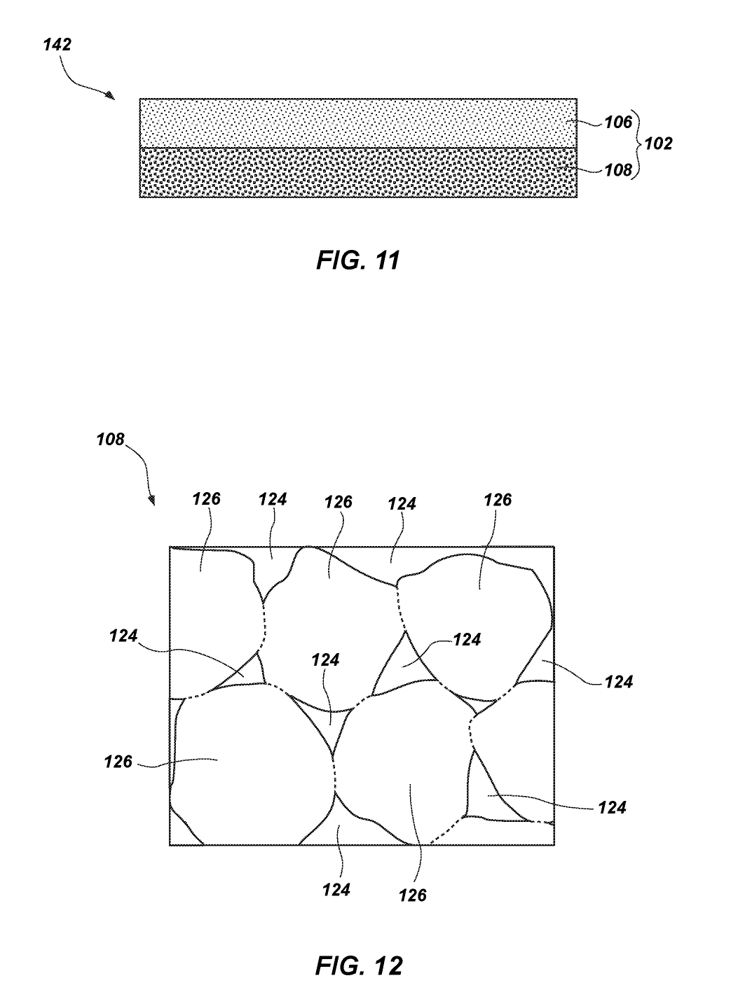

Referring to FIG. 11, an intermediate structure 142 in a process for attaching a polycrystalline table 102 to a substrate 104 is shown. The intermediate structure 142 may comprise a polycrystalline table 102 of superabrasive polycrystalline material. The polycrystalline table 102 may comprise a first region 106 having a first permeability and a second region 108 having a second, greater permeability. In embodiments where the polycrystalline table 102 is formed on an end of a substrate 104, the substrate 104 may be removed from the polycrystalline table 102, for example, by electrical discharge machining, by dissolving in acid, by laser removal, by ultrasonic carbide machining, or by other processes for removing a substrate 104 of hard material known in the art. The intermediate structure 142 may be at least substantially free of catalyst material. Catalyst material may have been removed from the polycrystalline table 102 by a leaching agent, such as, for example, aqua regia. As the first region 106 of the polycrystalline table 102 may have a relatively low permeability, the polycrystalline table 102 may be exposed to the leaching agent for a greater amount of time to ensure that the first region 106 is at least substantially fully leached. For example, the polycrystalline table 102 may be leached for 3 weeks, 4 weeks, 5 weeks, or even longer to ensure that catalyst material is at least substantially removed from the polycrystalline table 102. A microstructure of the first region 106 of the polycrystalline table 102 may be substantially the same as the microstructure shown and described in FIG. 3.

Referring to FIG. 12, a simplified view of how a microstructure of the second region 108 of the intermediate structure 142 shown in FIG. 11 may appear under magnification. The second region 108 comprises grains 126 of superabrasive material that have formed inter-granular bonds in a polycrystalline structure. The interstitial spaces 124 among interbonded grains 126 are at least substantially free of catalyst material, as catalyst material may have been removed therefrom.

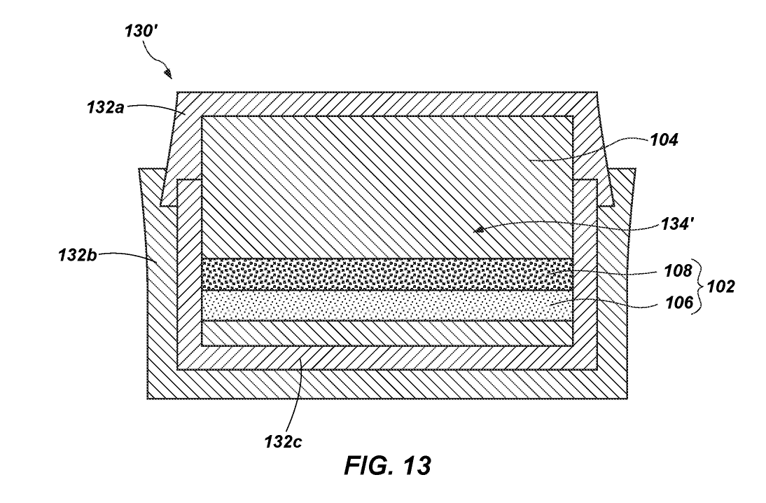

Referring to FIG. 13, a mold 130′ used in a process for attaching a polycrystalline table 102 to a substrate 104 is shown. The mold 130′ may be the same mold 130 shown in FIG. 10, or may be another mold. The at least substantially fully leached polycrystalline table 102 may be placed in the mold, and a substrate 104 may be placed in the mold as well. In some embodiments, the substrate 104 may be the same substrate 104 that was previously removed from the polycrystalline table 102. In other embodiments, the substrate 104 may be a different substrate comprising a hard material. In still other embodiments, a plurality of ceramic particles and metal particles may be disposed in the mold 130′ in the place of the fully formed substrate 104. A surface of the second region 108 of the polycrystalline table 102 opposing the first region 106 may abut an end surface of the substrate 104. The second region 108 may be interposed between the first region 106 and the substrate 104. The polycrystalline table 102 may then be attached to an end of the substrate 104, such as, for example, by subjecting the polycrystalline table 102 and the substrate 104 to another sintering process. The sintering process may be another HTHP process, or may involve pressures and temperatures that are lower than are required for an HTHP process. For example, the peak applied pressure may be less than 5 GPa, or may be 5 GPa, 6 GPa, 7 GPa, 8 GPa, or even greater. The peak temperature may be, for example, less than 1320° C., may be 1400° C., or may be even greater than 1400° C. In addition, the sintering process may remain at peak temperature and pressure for a relatively short time, such as, for example, less than 10 minutes, less than 8 minutes, less than 5 minutes, or even less than 2 minutes. As a specific, non-limiting example, the sintering process may remain at peak temperature and pressure for 5 minutes. Accordingly, a cubic press, as known in the art, may be particularly suited to apply pressure to the mold 130. Alternatively, a belt press, as known in the art, may be used to apply pressure to the mold 130. The exact conditions may be selected to impart a desired final microstructure (e.g., the microstructures depicted in FIGS. 3 and 4) and associated properties to the resulting polycrystalline table 102.

During the sintering process, a flowable material within the substrate 104, such as, for example, a metal catalyst material 134′ or a non-catalyst meltable material may melt and infiltrate the second region 108 of the polycrystalline table 102. In some embodiments, the catalyst material 134′ may be the same as the catalyst material 134 used to form the polycrystalline table 102. As a specific, non-limiting example, commercially pure cobalt may be used to both form the polycrystalline table 102 and to attach the polycrystalline table 102 to a substrate 104 after leaching. In other embodiments, the catalyst material 134′ may be different from the catalyst material 134 used to form the polycrystalline table. As specific, non-limiting examples, a cobalt-based alloy may be used to form the polycrystalline table 102 and a nickel-based alloy may be used to attach the polycrystalline table 102 to a substrate 104 after leaching, or a cobalt-based alloy may be used to form the polycrystalline table 102 and commercially pure cobalt may be used to attach the polycrystalline table 102 to a substrate 104 after leaching. In still other embodiments, a disc, foil, or mesh of catalyst material 134′ may be disposed between the polycrystalline table 102 and the substrate 104, however, the relatively low permeability of the second region 108 may render this unnecessary.

As the second region 108 may have a relatively low permeability, at least as compared to the first region 106, the flowable material may sweep into the second region 108 relatively quickly. Thus, time in the sintering process for attaching the polycrystalline table 102 to the substrate 104 may be reduced when compare to conventional reattach processes. In addition, the first region 106 may form a barrier that impedes the flow of catalyst material 134′ therein. Thus, the first region 106 may remain at least substantially free of catalyst material 134′ while catalyst material 134′ may be swept into the second region 108 of the polycrystalline table 102.

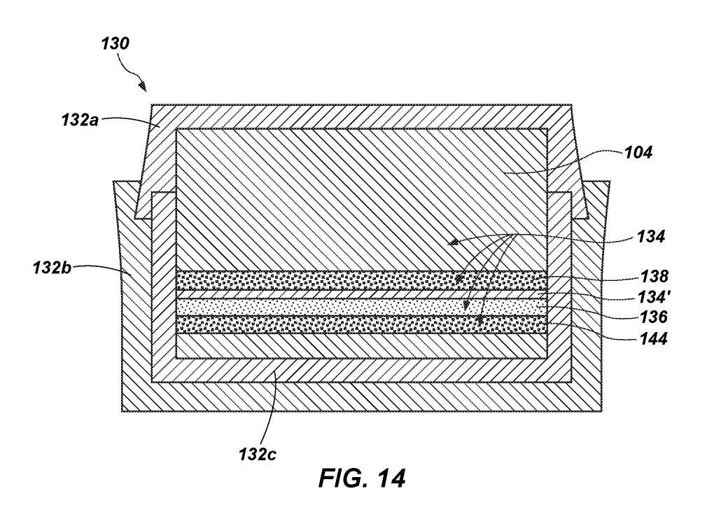

Referring to FIG. 14, a mold 130, similar to the mold 130 shown in FIG. 10, used in a process for attaching a polycrystalline table 102 to a substrate 104 is shown. In addition to the first and second pluralities of particles 136 and 138 of superabrasive material and the substrate 104, a third plurality of particles 144 comprising the superabrasive material may be disposed in the mold. The third plurality of particles 144 may be configured to form the third region 128 shown and described in connection with FIG. 6. Thus, the third plurality of particles 144 may be disposed on an end of the first plurality of particles 136 opposing the second plurality of particles 138. In other words, the first plurality of particles 136 may be interposed between the second plurality of particles 138 and the third plurality of particles 144. Catalyst material 134 may be distributed among the third plurality of particles 144 in the form of a catalyst powder or may be coated on the third plurality of particles. In addition, catalyst material 134 may be disposed in the mold 130 in the form of a disc, foil, or mesh. As shown, the catalyst material 134 may be disposed in the form of a disc, foil, or mesh between the first and second pluralities of particles 136 and 138. In other embodiments, the catalyst material 134 may be disposed in the form of a disc, foil, or mesh between the second plurality of particles 138 and the substrate 104, between the first plurality of particles 136 and the third plurality of particles 144, or on an end of the third plurality of particles 144 opposing the first plurality of particles 136.

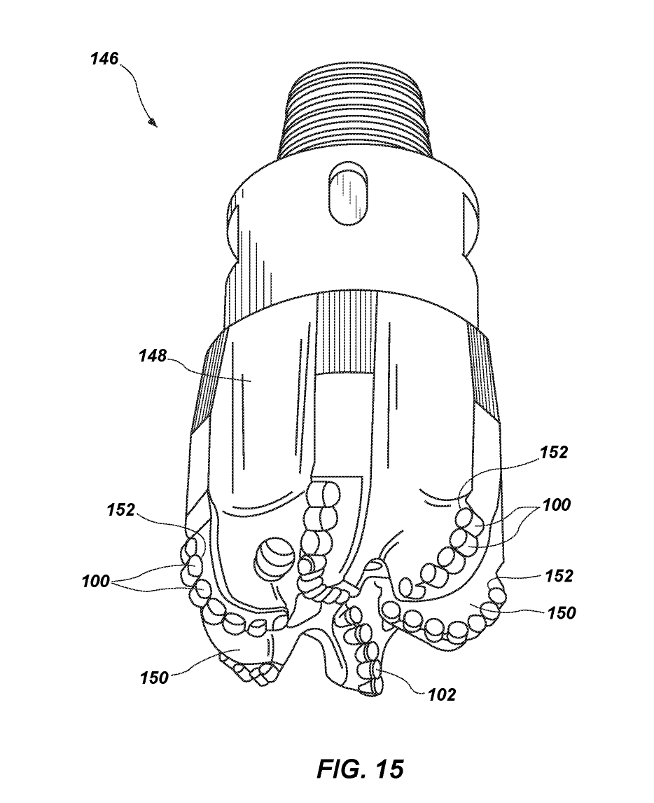

Referring to FIG. 15, an earth-boring tool 146 to which a cutting element 100 (e.g., any of the cutting elements 100 and 100′ described previously in connection with FIGS. 1, 2, and 5 through 9F) may be attached is shown. The earth-boring tool 146 may comprise an earth-boring drill bit and may have a bit body 148 with blades 150 extending from the bit body 148. The cutting elements 100 may be secured within pockets 152 formed in the blades 150. However, cutting elements 100 and polycrystalline tables 102 as described herein may be bonded to and used on other types of earth-boring tools, including, for example, roller cone drill bits, percussion bits, core bits, eccentric bits, bicenter bits, reamers, expandable reamers, mills, hybrid bits, and other drilling bits and tools known in the art.

While the present invention has been described herein with respect to certain embodiments, those of ordinary skill in the art will recognize and appreciate that it is not so limited. Rather, many additions, deletions, and modifications to the embodiments described herein may be made without departing from the scope of the invention as hereinafter claimed, including legal equivalents. In addition, features from one embodiment may be combined with features of another embodiment while still being encompassed within the scope of the invention as contemplated by the inventor.

What is claimed is:

1. A method of forming a polycrystalline element, comprising:
disposing a first plurality of particles comprising a superabrasive material, a second plurality of particles comprising the superabrasive material, and a catalyst material in a mold;
sintering the first and second pluralities of particles in the presence of the catalyst material to form a polycrystalline table comprising a first region having a first permeability and a second region having a second, greater permeability;
at least substantially removing the catalyst material from the polycrystalline table; and
attaching the polycrystalline table to an end of a substrate comprising a hard material, the at least a second region being interposed between the first region and the substrate.

2. The method of claim 1, further comprising:
disposing another substrate comprising a hard material in the mold prior to sintering;
sintering the first plurality of particles, the second plurality of particles, and the another substrate in the presence of the catalyst material to form a polycrystalline table comprising a first region having a first permeability and a second region having a second, greater permeability attached to an end of the another substrate, the second region being interposed between the first region and the another substrate; and
removing the another substrate after sintering.

3. The method of claim 1, further comprising:
disposing a third plurality of particles comprising the superabrasive material in the mold; and
sintering the first, second, and third pluralities of particles in the presence of the catalyst material to form a polycrystalline table comprising a first region having a first permeability, a second region comprising a second, greater permeability, and a third region disposed on an end of the first region opposing the at least a second region.

4. The method of claim 1, further comprising:
disposing another plurality of particles comprising a non-catalyst material removable by a leaching agent among the second plurality of particles in a region configured to form the second region after sintering.

5. The method of claim 1, wherein disposing a first plurality of particles comprising a superabrasive material, a second plurality of particles comprising the superabrasive material, and a catalyst material in a mold comprises disposing the first plurality of particles having a first packing density and the second plurality of particles having a second, lower packing density in the mold.

6. The method of claim 1, disposing a first plurality of particles comprising a superabrasive material, a second plurality of particles comprising the superabrasive material, and a catalyst material in a mold comprises disposing the first plurality of particles having a first average particle size and the second plurality of particles having a second, larger average particle size in the mold.

7. The method of claim 6, wherein disposing the first plurality of particles having a first average particle size and the second plurality of particles having a second, larger average particle size in the mold comprises disposing the first plurality of particles comprising at least some nanoparticles in the mold.

8. The method of claim 1, further comprising:
coating at least some of the first plurality of particles with the catalyst material using chemical solution deposition prior to disposing the first plurality of particles in the mold.

9. The method of claim 1, wherein sintering the first and second pluralities of particles in the presence of the catalyst material to form a polycrystalline table comprising a first region having a first permeability and a second region having a second, greater permeability comprises forming a polycrystalline table having a first region having a first volume percentage of superabrasive material and a second region having a second, lesser volume percentage of superabrasive material.

10. The method of claim 1, wherein sintering the first and second pluralities of particles in the presence of the catalyst material to form a polycrystalline table comprising a first region having a first permeability and a second region having a second, greater permeability comprises sintering the first and second pluralities of particles in the presence of the catalyst material to form a polycrystalline table having a first region comprising a first volume percentage of catalyst material disposed in interstitial spaces among interbonded grains of superabrasive material and a second region comprising a second, greater volume percentage of catalyst material disposed in interstitial spaces among interbonded grains of superabrasive material.

11. The method of claim 1, wherein attaching the polycrystalline table to an end of a substrate, the at least a second region being interposed between the first region and the substrate comprises infiltrating at least the second region of the polycrystalline table with a flowable material from the substrate during a sintering process.

12. The method of claim 11, wherein infiltrating at least the second region of the polycrystalline table with a flowable material from the substrate during a sintering process comprises infiltrating at least the second region of the polycrystalline table with another catalyst material different from the catalyst material used to form the polycrystalline table.

13. A method of attaching a polycrystalline table to a substrate, comprising:
forming a polycrystalline table of superabrasive material and comprising a first region having a first permeability and a second region having a second, greater permeability;
at least substantially removing catalyst material from the polycrystalline table;
contacting the polycrystalline table on an end of a substrate comprising a hard material, the second region being interposed between the first region and the substrate; and
infiltrating at least the second region of the polycrystalline table with a flowable material from the substrate.

14. The method of claim 13, wherein forming a polycrystalline table of superabrasive material and comprising a first region having a first permeability and a second region having a second, greater permeability comprises forming the polycrystalline table comprising a third region disposed on an end of the first region opposing the at least a second region.

15. The method of claim 13, wherein forming a polycrystalline table of superabrasive material and comprising a first region having a first permeability and a second region having a second, greater permeability comprises forming the polycrystalline table having a first region comprising interstitial spaces among interbonded grains of superabrasive material with a first interconnectivity and a second region comprising interstitial spaces among interbonded grains of superabrasive material with a second, greater interconnectivity.

16. The method of claim 13, wherein forming a polycrystalline table of superabrasive material and comprising a first region having a first permeability and a second region having a second, greater permeability comprises forming the polycrystalline table comprising a first region having a first density of superabrasive material and a second region having a second, lesser density of superabrasive material.
